(19) United States
(12) Patent Application Publication
(10) Pub. No.: US 2023/0358654 A1
(43) Pub. Date: Nov. 9, 2023

(54) Methods Circuits Devices Assemblies Systems and Functionally Associated Machine Executable Code for Detecting Structural Cracking or Breaking a Functional Element

(71) Applicant: David Solomon, Zihron Yacov (IL)

(72) Inventor: David Solomon, Zihron Yacov (IL)

(21) Appl. No.: 17/662,603

(22) Filed: May 9, 2022

Related U.S. Application Data
(60) Provisional application No. 63/364,395, filed on May 9, 2022.

(51) Int. Cl. G01N 3/20; G01N 3/06

(52) U.S. Cl. CPC G01N 3/20; G01N 3/066

(57) ABSTRACT

Disclosed are methods, assemblies, devices and systems for detections of a crack or break in a functional element, such as a load-baring element of structure, a fluid storage or transport element and or an electrical conductor of an electricity storage device. Embodiments of the present invention include a surface wave sensor comprised of: (a) at least a first and second bend detection strips located in proximity with one another and each disposed on or within a substrate, wherein at least one of said bend detection strips exhibits an electrical characteristic corresponding to a direction of bend or bending of said bend detection strips; and (b) one or more electrical contacts affixed to electrically active areas on respective bend detection strip to facilitate measurement of an electrical characteristic exhibited by each respective bend detection strip. A controller or control circuit according to embodiments may monitor the electrical characteristic exhibited by each of said bend detection strips and may generate a surface wave detection signal or notification when a set of exhibited electrical characteristics meet one or more predefined conditions.

### RELATED APPLICATIONS

The present patent application claims priority from U.S. Provisional Patent Application No. 63/364,395, filed on 9 May 2022, the disclosure of which is herein incorporated by reference in its entirety.

### FIELD OF THE INVENTION

The present invention relates generally to the field of sensing. More specifically, the present invention relates to methods, circuits, devices, assemblies, systems for detecting cracking or breaking of a functional element, such as a structural element of a building or structure, a material transport element and or a electrically conducting element.

### BACKGROUND

Monitoring of structural support elements of various structures or buildings and/or operational elements of various machines or industrial equipment, collectively referable to as “functional elements”, has been performed for safety and downtime mitigation purposes for many years now. To date, most common monitoring techniques employ manual inspection, either performed according to a schedule or responsive to some indications at or near the subject functional element. Quite often, an inspection of a suspect element will also include an inspection of structures or machines to which the element is connected.

Acoustic Emission (AE) is a general term for vibrations that are generated by micro-cracks from dislocation of solid crystal structures. There are different vibration wave modes in solids that are generated by dislocation inside a material. There are bulk waves—P waves that are compression waves, S—share waves; surface waves that include Rayleigh in bulk, and Lamb waves in sheets and pipes. Detection of any one or more of these types of waves can be indicative of a crack or other failure within a functional element. Monitoring for one or more of these types of waves can be used for automated functional element degradation detection, whether due to stress, age, chemical or other causes.

To date, automated continuous monitoring for AE in large structures or complex machines or devices has remained extremely challenging and rare. For the reasons to be elaborated directly below, continuous functional element monitoring, although known, is not employed widely.

Although monitoring, manually or through a sensor, for Acoustic Emissions indicative of element deterioration is a known method of non-destructive testing of elements used for structures and other materials, it is complicated to implement. Although the acoustic emissions detection method makes it sometimes possible to detect micro-cracks, cracks and corrosion processes in solids, by detection vibrations in an ultrasound range, the broad range of acoustic vibration band (from 30 khz to 300 khz) makes sensor selection and installation makes the use of prior art sensors almost impossible. More specifically, today's state of the art sensors for acoustic emission that are based on piezo-electric crystals or ceramics, such as PZT, that are designed to resonate in a compression mode. These resonance type sensors, in which the piezo crystal length is set to equal the half wavelength of the working frequency, are complex and expensive to produce and thus tend to have various demotivational drawbacks, such as:
1. Very expensive as it requires large, highly uniform piezo-crystals/ceramics;
2. Resonant mode of operation distorts the signal;
3. Narrow operating bandwidth of the sensor that depends on the crystal length;
4. Large volume of material due to large size of the crystal; and
5. Very low capacitance that require very high input impedance amplifiers.

There is therefore a need in the fields of monitoring and maintenance for improved sensors and sensing methods.

### SUMMARY OF THE INVENTION

Embodiments of the present invention may include methods, circuits, devices, assemblies, systems and functionally associated machine executable code for detecting physical cracking or breaking in an element integral or otherwise associated with a structure, infrastructure or an article of manufacture. According to some embodiments, surface waves generated by a crack or break in each element may be detected and or characterized by a transducer type sensor located at or near the surface of the element. Acoustic Emission (AE) is a general term for vibrations that are generated by micro-cracks from dislocation of solid crystal structures which generate vibrations in solids om modes including: (1) bulk waves, (2) pressure or compression waves, (3) share waves; and (4) surface waves that include (4a) Rayleigh in bulk and (4b) Lamb waves in sheets and pipes.

As a crack or physical break triggered vibration, usually surface wave, travels past a sensor according to embodiments of the present invention, the vibration may cause the sensor to concurrently generate two or more consecutive related electrical signals whose respective characteristics, when compared to one another may be correlated to the characteristics of the surface wave.

A system according to embodiments of the present invention may include at least one such transducer type sensor and at least one electronic controller to receive and process one or more signals generated by the least one such transducer type sensor. Systems according to embodiments of the present invention may include some numbers of transducer type sensors, each at least partially composed of a set of two or more physical bend sensing elements in proximity with one another, to be distributed across one or more elements of a structure or article of manufacture.

A surface wave sensor according to embodiments of the present invention may include at least first and second bend or bending detection strips disposed on or within a substrate and located in proximity with one another. The surface wave sensors composed of the at least two bending detection strips may be place placed on a surface of the object to be monitored.

According to some embodiments, the bending detection strips may be placed adjacent to one another, possibly positioned end to end—for example two strips may be disposed next to one another such that the bottom end of the first strip may be located directly next to the top of the second strip. Each of the at least first and second bend detection strips may be composed of a material, or a sandwich of multiple layers of material, which exhibits an electrical characteristic responsive to physical bending and or corresponding to a direction of physical bend or bending of the respective detection strip. For example, a bending detection strip may generate some electrical potential across two electrically active points on the bend detection strip when the strip is bent in one direction some number of degrees, and the same bending detection strip may generate an opposite electrical potential across the two active points when bent in the other direction.

The substrate of a sensor according to embodiments of the present invention with which the at least first and second sensing strips may be associated may be physically flexible and may be electrically insulative. The substrate may be thermally insulative as well. The sensing strips and substrate may be assembled or otherwise produced to provide electrical access to electrically active points on each of the at least two sensing strips. Each of the at least two sensing strips' electrically active points may be accessible and electrically sampleable from outside of the assembly by one or more monitoring circuits. One or more electrical contacts on each of said bend detection strips may facilitate measurement of their respective strip's exhibited electrical characteristic. The electrical characteristic monitoring circuits may be integral with the sensor, or the circuits may be part of a device electrically connected to the sensor via electrical conductors.

Monitoring circuits according to embodiments of the present invention may include a one or more signal amplifiers, including low noise amplifiers (LNA) and differential amplifiers. Various amplifier types and other types of electrical circuits (e.g. analog to digital computers, current or voltage measurement circuits, etc.) may be used for sensing and monitoring electrical characteristics of bend/bending sensing strips. According to further embodiments, the monitoring circuit may be configured to indicate or generate a surface wave detection signal or record when the circuit receives electrical signals from each of the at least first and second bending detection strips indicating that each is bent in a direction opposite from the bending direction of the other. According to even further embodiments, a monitoring circuit terminal may connect to a common node of the at least first and second strips in an assembly, wherein a common node is a node which electrically short circuits an electrically active point on one sensing strip to an electrically active point on another sensing strip. Other, non-common, terminals of the monitoring circuits may each be connected to electrically active points on opposite ends of the sensing strip assembly. For example, in an assembly where two sensing strips are placed adjacent to one another and share a common-node to which a common terminal of a monitoring circuit is connected, a first non-common terminal of the monitoring circuit may be connected to a non-common electrically active point on the first sensing strip and a second non-common terminal of the monitoring circuit may be connected to a non-common electrically active point on the second sensing strip.

According to some embodiments, the monitoring circuit may include: (1) an analog portion for connecting to one or more surface wave sensors and monitoring their respective electrical characteristics (e.g., electrical signals); (2) processing logic to convert electrical signals from connected sensors to into information relating to possible surface wave detections; and (3) a digital communication portion to communicate with and send surface wave detection notifications to one or more network nodes of a monitoring system. According to further embodiments, the monitoring circuits may include a time stamping mechanism usable to associate a time stamp or time reference with the point in time of surface wave detections.

A monitoring circuit according to embodiments of the present invention may be integral or otherwise functionally associated with a sensor controller, which sensor controller may monitor one or more sensors concurrently. According to some embodiments, a given controller may be integral with a sensor, while according to other embodiments the given controller may be electrically connected to multiple sensors positioned within some proximity to one another, optionally on the same element. A controller connected to multiple sensors located on a single element may determine a direction of arrival of a surface wave, optionally by detecting which sensor detected the surface wave first. By measuring a time delay between surface wave detection at a first sensor and a second sensor, wherein the sensor's positions and relative distances from one another are known, the controller may estimate a velocity of the surface wave. By measuring surface wave amplitude attenuation between the two or more sensors, an attenuation per unit length (e.g. centimeter) parameter can be estimated. Based on an assumption regarding a surface wave's initial amplitude, possibly derived from experimentation and empirical data collection from the element being monitored, and factoring an estimated attenuation per unit length, a surface wave amplitude measurement at one of the sensors can be used to estimate a distance on the element of the surface wave source (i.e., the crack) from the detecting sensors.

According to embodiments where three or more sensors are placed or are otherwise attached to a common structural element, and optionally are electrically connected to the same of functionally associated with a controller, a direction of arrival of a surface wave may be estimated by comparing the time of detection of the surface wave at each of the three or more sensors and then triangulating a direction of the source of the surface wave. Like with the two sensor embodiments previously mentioned, a distance of the source of a surface wave from one or more sensors may also be estimated by first estimating a wave attenuation per unit length, applying an assumption of an initial wave amplitude and measuring the amplitude at a given sensor.

Sensors according to embodiments of the present invention may include or more piezo elements, usually in the form of a strip, may act as bending actuated transducers or sensors. Responsive to being bent by a passing surface wave, piezo elements according to embodiments of the present invention may exhibit an electrical potential across two or more electrical contacts of the piezo element, wherein an amplitude of the exhibited potential may be a function of the extent of bending and the polarity of the exhibited potential may be a function of a direction of bending of the piezo element.

Bending mode piezo elements can be referred to as “a Bender” or “Benders”. Bender piezo elements according to embodiments of the present invention may be fixed on its edge and air or liquid pressure applied may deform the piezo element such that it flexes and generates an electrical charge. Benders that are fixed on the edge may be sensitive to frequencies up to 5-8 kHz, which frequency may depend on the Bender geometry, material, and thickness. Benders produced and placed according to embodiments of the present invention, alone or in sets, may be utilized to detect shearing and or surface waves propagating through a structure or material being or to be monitored by devices and systems according to embodiments of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a background art sensor device used for elastic wave detection connected to a top surface of an element in which a crack on a right side of the element triggers bulk waves which result in surface waves propagating across the top surface of the element from right to left;

FIG. 2 is an illustration of exemplary functional element to which an exemplary surface-wave sensor according to embodiments of the present invention is connected, as detailed in a “zoom-in” of the functional components of the sensor, and through which a surface wave is propagating from right to left;

FIG. 3 shows an exemplary sensor assembly and device produced according to embodiment of the present invention where functional sensor elements are packaged in a flexible casing to form a sensor device;

FIG. 4 shows an exemplary sensor assembly and device according to embodiment of the present invention where functional sensor elements are encapsulated in a polymer envelope to form a sensor device;

FIGS. 5a to 5c are cross sectional views of three separate (piezo) electrode geometries, each with specific qualities, attributes and or parameters by which sensors according to embodiments of the present invention can be configured or tuned, including wave frequency tuning, and direction sensitivity configuration;

FIGS. 6a and 6b are symbolic representations of how a sensor element according to embodiments of the present embodiment may be configured to detect timing and thus direction of arrival of one or more emissions traveling across a surface of an element being monitored;

FIG. 7 is an exemplary differential voltage measurement device constructed to make differential voltage measurements between electrodes emanating from different electrically active areas of a sensor assembly according to embodiments of the present invention, including those shown in FIGS. 2, 3a, 3b, 5a, 5b, 5c, 6a and 6b; and

FIG. 8 is a symbolic illustration of a dual sensor element arrangement, according to embodiments of the present invention, capable to estimate a direction of arrival and possibly triangulate a location of a surface wave source (e.g. crack).

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Embodiments of the present invention may include a surface wave sensor for detection of a surface wave propagating on a surface of a monitored functional element. The sensor may comprise at least first and second bend detection strips disposed on or within a substrate and located in proximity with one another. At least one of the bend detection strips may exhibit an electrical characteristic with a polarity corresponding to a direction of bending experienced by the least one bend detection strip. One or more electrical contacts affixed to electrically active areas on each respective bend detection strip may facilitate monitoring and or measurement and or sampling of electrical characteristic exhibited by the respective bend detection strip.

According to embodiments of the present invention, dimensions of each individual bend detection strip and spacing between two adjacent strips may be selected to induce opposite polarities across two adjacent bend detection strips when a surface wave of interest propagates across a surface of a functional element with which said sensor is in contact.

According to some embodiments, at least one of the bending detection strips may exhibit an electrical characteristic with a magnitude corresponding to an extent of bending experienced by the bend detection strip. A bend detection strip according to embodiments may be composed of one or more of the following: (1) a piezoceramic material, (2) a layered composite of a piezoceramic material and a metal, (3) a layered composite of two different metals, (4) a dielectric material, (5) a layered composite of dielectric material sandwiched between metal layers, and (6) any combination of the previously mentioned materials and arrangements. The electrical characteristic exhibited by a detection strip according to embodiments may be: (1) electrical potential, (2) electrical resistance, (3) electrical impedance, (4) electrical capacitance, and (5) electrical impedance.

A substrate of a sensor according to embodiments may be a common substrate on to which, or within which, two or more bend detection strips may be placed. A substrate of a sensor according to embodiments of the present invention may include a contact surface adapted for affixation to a surface of a functional element to be monitored. The substrate contact or affixation surface may be adapted to connect to one or more of: (1) a loadbearing element of a structure, (2) fluid storage or transport elements, and (3) electrically conductive element of a battery, and (4) rotational machines that might experience friction and cracking.

The sensor according to embodiments may include or be otherwise associated with a controller or control circuit to monitor the electrical characteristic exhibited by each of the bend detection strip of the sensor. The controller may be adapted to generate a surface wave detection signal or notification when a set of exhibited electrical characteristics meet one or more predefined conditions. The control circuit may be configured to generate a signal indicating detection of a surface wave upon one or more of the exhibited electrical characteristics meeting one or more of the following conditions: (1) at least two of said bend detection strips exhibit different electrical characteristics, (2) at least two of said bend detection strips exhibit opposing electrical potentials, (3) a frequency of an electrical signal generated by at least one bend detection strip corresponds to a frequency of a surface wave of interest.

The control circuit monitors according to embodiments of the present invention may be connected to one or more multiple surface wave sensors placed on a common functional element and may estimate direction of arrival of a detected surface wave.

A control circuit according to embodiments of the present invention may include or be otherwise functionally associated with a digital communication module adapted to transmit notifications of surface wave detections to a remote computer. The control circuit may be adapted to estimate surface wave characteristics such as amplitude, speed of travel, direction of arrival, attenuation per unit distance traveled and a distance of a surface wave source, such as a crack or break in a monitored element, from a functionally associated sensor.

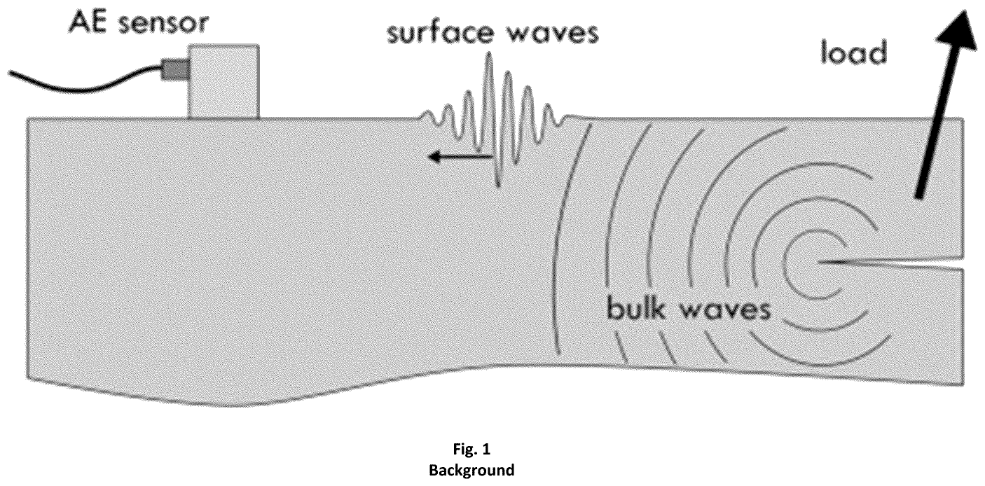

Turning now to FIG. 1, there is shown an exemplary prior art resonance type sensor device, usable for elastic waves detection. The illustration shows the prior art device connected to the surface of a monitored element in which a crack triggers a multitude of elastic waves propagating in the direction of the prior art resonance type detector. The prior art sensors is affixed to the surface of the monitored element by adhesive or through the application of pressure. The electrical signal generated by the sensor is not an accurate representation of the detected surface waveform nor does it indicate the direction or distance to the source of the surface wave.

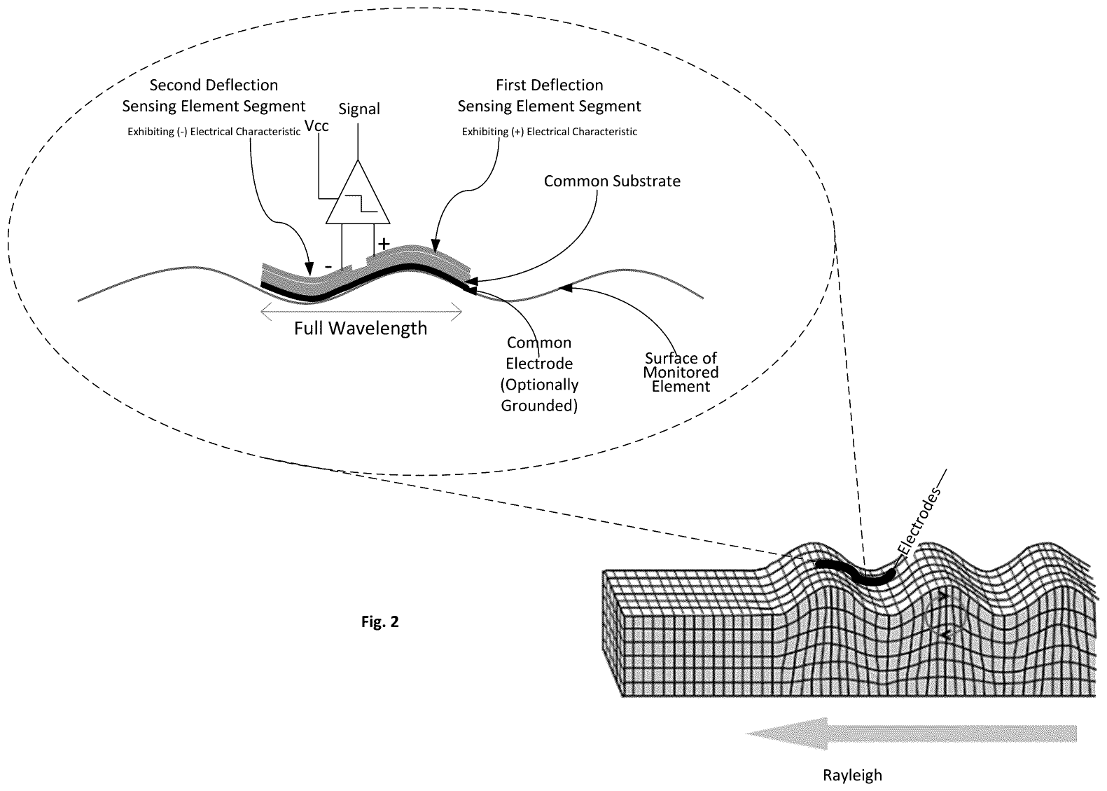

Turning now to FIG. 2, there is shown an exemplary surface wave sensor according to embodiments of the present invention. The sensor is provided in a formfactor of a thin film strip, is flexible and affixed onto the surface of a functional element being monitored. Also shown in FIG. 2 is a surface wave is propagating across from right to left.

The illustration of FIG. 2 also includes a zoom-in on the surface wave sensor provided as a thin film strip. The zoom-in illustrates some of the functional elements of the sensor, including: (a) two bend sensing segments, each with a separate electrode contact; (b) a common substrate; and a common electrode which facilities differential measurement of electrical characteristic (e.g. voltage) between the electrodes of the two bend sensing segments. The casing or covering of the sensor is not shown in FIG. 2. Also visible in the zoom-in view of FIG. 2 is an optional differential amplifier which can be integral or otherwise functionally associated with the thin film sensor components. All voltage measurements on the sensor may be made relative to the common terminal voltage, which common terminal may be connected to a common ground.

The surface wave sensor illustration of FIG. 2 highlights various novel aspects of the present invention relating to structure cracking or structural failure detection in functional elements using thin-film sensor for surface wave detection. More specifically, FIG. 2 illustrates a surface wave sensor operating on a principle of real-time detection of surface bending of a surface to which the sensor is affixed. The surface wave sensor according to embodiments of the present invention, including the one shown in FIG. 2, is composed of multiple sensor segments in proximity with each other, for example placed lengthwise next to each other, wherein at least each of two of the segments includes a separate bend or bending sensor.

The bending sensor is of FIG. 2 is composed of a transducer type material, such as piezo films or sandwiches of film material including piezo or a dielectric which acts as a transducer, converting a physical force or movement of the bending sensor into an electrical characteristic. The piezo element, in the form of a film or strip, as shown in the bend or bending sensors of FIG. 2 responds to a bend or bending of the piezo element with a change in measurable electric potential between two electrical contact points on the piezo element. The direction or polarity of the electric potential generated across the piezo film strip is a function of the direction of the bend or bending and the magnitude of the electric potential is related to an extent of bending.

As bend sensors (“bend” and “bending” are used interchangeably in this document when referring to sensors and sensor elements) located in different segments of the surface was sensor enable detection of a wave as it propagates across the surface of the functional element onto which the sensor is attached. The sensor of FIG. 2, using multiple piezo elements in a bending mode detects shear and surface waves from a structure or material of interest by comparing the electrical potential signals produced by each of the piezo elements relative to the other.

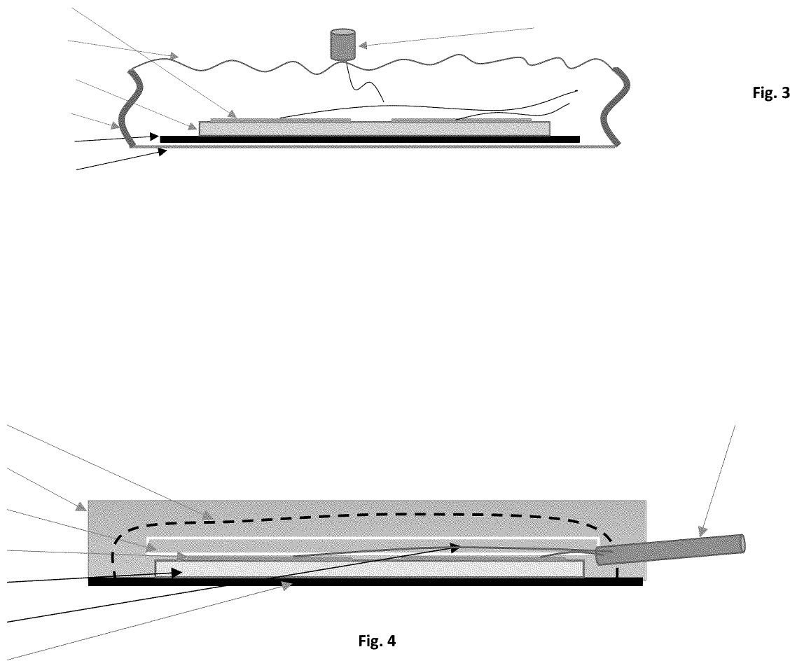

Examples of bending mode piezo elements, also referred to benders “BENDERS” is a thin piezo element with specific dimensions and a special electrode structure designed to pick up a specific wavelength range, attached to a surface by glue or pressure. As surface waves change the surface shape, the piezo element bends and generates an electric charge that can be amplified, filtered and measured. The enclosure of the sensor element must have a flexible design, as shown in FIGS. 3 and 4, which enables it to bend with the surface.

Turning now to FIG. 3, there is shown an exemplary sensor device according to embodiment of the present invention where functional sensor elements are packaged in a flexible case or enclosure. The side walls of the casing are elastic and collapsible and the barrier between the sensor elements inside of the case and the surface of the functional element to be monitored is highly flexible.

FIG. 4 shows an exemplary sensor device according to embodiment of the present invention where functional sensor elements are encapsulated in a flexible envelope, optionally made from polymer, plastic, or rubber. The envelope includes a thin barrier between the sensing elements and the functional element contact surface and is generally characterized by high elasticity couple with environmental fastening.

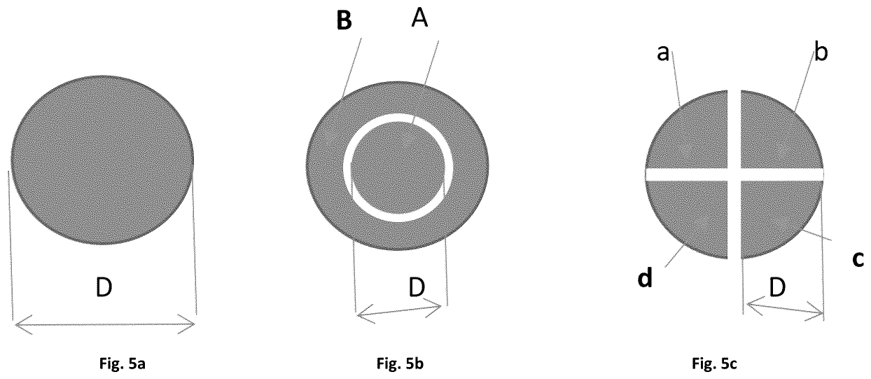

FIGS. 5a to 5c are cross sectional views of three separate (piezo) sensing element geometries, each with specific qualities, attributes and or parameters by which sensors according to embodiments of the present invention are configured or tuned, including wave frequency tuning, and direction sensitivity configuration. The differing geometries of the sensor element configuration shown in FIGS. 5a, 5b, and 5c impact different functional of the sensor using these elements, such as sensitivity to surface wave frequencies or frequency bands.

FIG. 5a illustrates the simplest sensor element configurations wherein the sensor or electrode it is equally sensitive to waves from all directions and the frequency band of the waves to which sensor element is sensitive depends on dimension D.

FIG. 5b shows the sensor element/electrode configuration adapted to increase the surface wave detection frequency band. The adaptation includes providing a second concentric sensing element with a decreased dimension D. According to this methodology, there can be provided several concentric circuits to match the electrode dimension to the desired frequency response. All these concentric configurations are characterized with omni-directional sensitivity to surface waves (i.e. equal response to waves arriving from any direction).

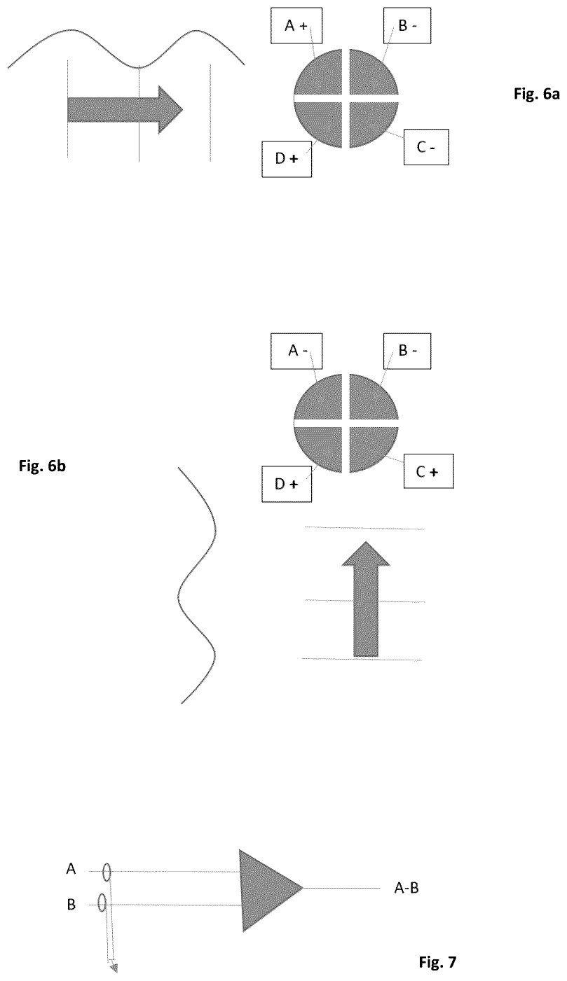

FIG. 5c shows the electrode configuration that is sensitive to the direction of the waves that are further explained in FIGS. 6a and 6b. The dimension D is determined by the electrode size by division liner division of the electrode to 4 or more parts. Linear division can be combined with circular division to create any size of electrode to fit the frequency or frequency bands to be detected.

The geometry of a bend sensing element defines the center frequency of the band of frequencies of surface waves to which the sensing element is most sensitive. Peak sensitivity for a specific surface wave frequency is achieved when the length of the element is ½ the wavelength of the surface wave frequency.

Turning now to FIGS. 6a and 6b, are symbolic representations of how a sensor element according to embodiments of the present embodiment may be configured to detect timing and thus direction of arrival of one or more emissions traveling across a surface of an element being monitored. FIG. 6a shows the selective polarization that is sensed by the electrodes that is generated by the wave with X direction. Since the piezo bending is along one direction, the electrodes A and D have positive polarization, while electrodes B and C have negative polarization, and it changes of course as the wave propagates. In FIG. 6b it can be seen that Y direction of waves create polarization of A, B as negative, and D, C are positive.

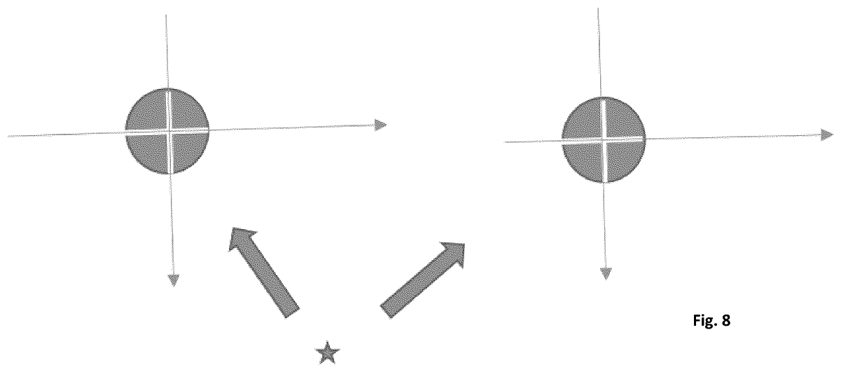

FIG. 7 illustrates an exemplary differential voltage measurement device constructed to make differential voltage measurements between electrodes emanating from different electrically active areas of a sensor assembly according to embodiments of the present invention, including those shown in FIGS. 2, 3a, 3b, 5a, 5b, 5c, 6a and 6b. To detect the wave direction this differential measurement device is used to measures 4 values by differential measurement, between 2 electrodes at a time, as depicted by measuring circuit in FIG. 7.

Where connected to terminals as designated below, the output will equal the differences of the voltages, as designated below:

AB=A−B

AD=A−D

DC=D−C

BC=B−C
The X wave component Qx of the wave that creates charge Q is calculated by: Qx=AD−BC
The Y component Qy of the wave that creates charge Q is calculated by: Qy=DC−AB
These calculations can be performed in a processor or by using differential amplifier as shown in FIG. 7.

Finally, turning to FIG. 8, there is shown a symbolic illustration of a dual sensor element arrangement, according to embodiments of the present invention, capable to estimate a direction of arrival and possibly triangulate a location of a surface wave source (e.g. crack). FIG. 8 is an example of source (e.g. crack) localization using 2 directional sensors. Source localization by directionally sensitive sensors factors a combination of wave detection timing and detection amplitudes between two or more sensors elements with known relative locations and optionally known (sensing) directional gain. Based on the difference of time or detection and or relative detected signal strength, the source of a surface wave can be localized by the sensor configuration of FIG. 8.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A surface wave sensor for detection of a surface wave propagating on a surface of a monitored functional element, said sensor comprising:
at least first and second bend detection strips disposed on or within a substrate and located in proximity with one another, wherein at least one of said bend detection strips exhibits an electrical characteristic with a polarity corresponding to a direction of bending experienced by said at least one bend detection strips; and
one or more electrical contacts affixed to electrically active areas on each said bend detection strip to facilitate measurement of electrical characteristic exhibited by a respective said bend detection strip.

2. The sensor according to claim 1, wherein dimensions of each individual bend detection strip and spacing between two adjacent strips is selected to induce opposite polarities across said two adjacent bend detection strips when a surface wave of interest propagates across a surface of a functional element with which said sensor is in contact.

3. The sensor according to claim 1, wherein at least one of said bending detection strips exhibits an electrical characteristic with a magnitude corresponding to an extent of bending experienced by said at least one bend detection strip.

4. The sensor according to claim 1, wherein at least one of said bend detection strips is composed of one or more of: (1) a piezoceramic material, (2) a layered composite of a piezoceramic material and a metal, (3) a layered composite of two different metals, (4) a dielectric material, (5) a layered composite of dielectric material sandwiched between metal layers, and (6) any combination of the previously mentioned materials and arrangements.

5. The sensor according to claim 1, wherein said substrate includes a contact surface adapted for affixation to a surface of a functional element to be monitored.

6. The sensor according to claim 1, wherein the electrical characteristic exhibited by each of one or more bend detection strips is selected from the group consisting of: (1) electrical potential, (2) electrical resistance, (3) electrical impedance, (4) electrical capacitance, and (5) electrical impedance.

7. The sensor according to claim 6, further comprising a control circuit to monitor the electrical characteristic exhibited by each of said bend detection strips and to generate a surface wave detection signal or notification when a set of exhibited electrical characteristics meet one or more predefined conditions.

8. The sensor according to claim 7, wherein said control circuit is configured to generate a signal indicating detection of a surface wave upon one or more of the exhibited electrical characteristics meeting one or more of the conditions: (1) at least two of said bend detection strips exhibit different electrical characteristics, (2) at least two of said bend detection strips exhibit opposing electrical potentials, (3) a frequency of an electrical signal generated by at least one bend detection strip corresponds to a frequency of a surface wave of interest.

9. The sensor according to claim 7, wherein said control circuit includes or is functionally associated with a digital communication module adapted to transmit notifications of surface wave detections.

10. The sensor according to claim 1, wherein said substrate is a common substrate for all said bend detection strips and the affixation surface of said common substrate is adapted to be attached to a surface of said functional element to be monitored.

11. The sensor according to claim 10, wherein the affixation surface is adapted to connect to one or more of: (1) a loadbearing element of a structure, (2) fluid storage or transport elements, and (3) electrically conductive element of a battery.

12. A system for detections of a crack or break in a functional element, said system comprising:
a surface wave sensor comprised of: (a) at least a first and second bend detection strips located in proximity with one another and each disposed on or within a substrate, wherein at least one of said bend detection strips exhibits an electrical characteristic corresponding to a direction of bend or bending of said bend detection strips; and (b) one or more electrical contacts affixed to electrically active areas on respective bend detection strip to facilitate measurement of an electrical characteristic exhibited by each respective bend detection strip; and
a control circuit to monitor the electrical characteristic exhibited by each of said bend detection strips and to generate a surface wave detection signal or notification when a set of exhibited electrical characteristics meet one or more predefined conditions.

13. The system according to claim 12, wherein at least one bend detection strips is composed of one or more of: (1) a piezoceramic material, (2) a layered composite of a piezoceramic material and a metal, (3) a layered composite of two different metals, (4) a dielectric material, and (5) a layered composite of dielectric material sandwiched between metal layers.

14. The system according to claim 12, wherein said control circuit is configured to generate a signal indicating detection of a surface wave upon one or more of the exhibited electrical characteristics meeting one or more of the conditions: (1) at least two of said bend detection strips exhibit different electrical characteristics, (2) at least two of said bend detection strips exhibit opposing electrical potentials, (3) a frequency of an electrical signal generated by at least one bend detection strip corresponds to a frequency of a surface wave of interest.

15. The system according to claim 12, wherein said control circuit monitors multiple surface wave sensors placed on a common functional element and estimates direction of arrival of surface wave.

16. The system according to claim 12, wherein said control circuit is adapted to estimate a distance of a surface wave source from a functionally associated sensor.

17. The sensor according to claim 12, wherein said control circuit includes or is functionally associated with a digital communication module adapted to transmit notifications of surface wave detections.
